(19) United States
(12) Patent Application Publication
(10) Pub. No.: US 2026/0242622 A1
(43) Pub. Date: Aug. 20, 2026

(54) DISPERSION LIQUID, METHOD FOR PRODUCING SAME, AND CURED PRODUCT THEREOF

(71) Applicant: TAYCA CORPORATION, Osaka (JP)

(72) Inventors: Yui AKIHARA, Osaka (JP); Yuichi KAMEI, Osaka (JP)

(21) Appl. No.: 18/874,575

(22) PCT Filed: Jun. 14, 2023
(86) PCT No.: PCT/JP2023/022034

§ 371 Date: Dec. 12, 2024

(30) Foreign Application Priority Data
Jun. 15, 2022 (JP) 2022-096528

(51) Int. Cl. C09D 7/62; C08K 5/5425; C08K 9/02; C09D 7/63; C09D 7/80; C09D 133/08; C09D 133/14; C09D 133/26; C09D 135/02

(52) U.S. Cl. CPC C09D 7/62; C09D 7/63; C09D 7/80; C09D 133/08; C09D 133/14; C09D 133/26; C09D 135/02; C08K 5/5425; C08K 9/02; C08K 2201/006

(57) ABSTRACT

There is provided a dispersion comprising titanium oxide particles, a silane coupling agent and a monomer having a polymerizable functional group, wherein the titanium oxide particles are particles of a rutile-type titanium oxide whose core is surface-treated with a hydrous oxide of tin or zirconium, wherein a viscosity of the monomer at 25° C. is 100 mPa·s or less; the amount of an ignited solid when the dispersion is ignited at 925° C. for 2 hours is 15 to 55% by mass; a content of the silane coupling agent in the dispersion is 2 to 15% by mass; a content of the monomer is 30 to 85% by mass; a content of an organic solvent having no polymerizable functional groups is 10% by mass or less; and a viscosity of the dispersion at 25° C. is 500 mPa·s or less. Thus, there is provided a curable dispersion which contains titanium oxide particles, has a higher refractive index, exhibits excellent transparency, has a low volatile solvent content, exhibits a low viscosity, and exhibits excellent viscosity stability.

### TECHNICAL FIELD

The present invention relates to a dispersion containing titanium oxide particles and a production method therefor. It also relates to a curable sealant made from the dispersion. It also relates to a cured product prepared by curing the dispersion.

### BACKGROUND ART

Many electronic devices are susceptible to deterioration due to oxygen and/or moisture, so they are extensively protected with a sealant made of a curable resin. Various sealants therefor are known, depending on an application.

For example, for optical elements, a luminescent material is susceptible to deterioration by moisture and/or oxygen, so the optical element must be sealed. When sealing an optical element, in the light of brightness and clarity, it is important that the light emitted from the element can be efficiently taken out to the outside. Therefore, a sealant must be transparent and have a high refractive index. A high refractive index makes it possible to reduce a difference in refractive index between the sealant and the high refractive index member constituting the optical element, thereby reducing loss of light due to reflection and refraction.

For this reason, various sealants having a high refractive index and excellent transparency have been proposed as a sealant for an optical element. For example, Patent Literature 1 describes a resin composition comprising a compound containing multiple sulfur atoms and aromatic rings and having a reactive functional group; a compound having a polymerizable double bond and an aromatic ring; and a photocationic polymerization initiator, and a cured product with a high refractive index can be obtained by curing the resin composition, which is useful as a sealant for organic EL elements. Furthermore, Patent Literature 2 has described an epoxy-polymerizable composition comprising an S-containing epoxy compound, a thiol compound having multiple thiol groups in one molecule, and a curing accelerator, which has a high refractive index and thus is useful as a sealant for organic EL elements. Patent Literature 2 has also described that adhesiveness to a substrate can be improved by further blending a silane coupling agent into the composition. However, special compounds must be used to produce such compositions.

Patent Literature 3 has described a curable composition, as a sealant for organic EL elements, containing a compound having a polymerizable double bond bonded to a naphthalene ring and a polymerization initiator, which is solvent-free and has a low viscosity, and gives a cured film having a high refractive index. Patent Literature 3 has also described that a refractive index of the resulting cured product can be further increased by blending the composition described in Patent Literature 3 with metal oxide particles having a primary particle diameter of 100 nm or less and a refractive index of 1.6 or more such as titanium oxide particles. It is, however, difficult to disperse titanium oxide particles to the order of several tens nm, and it is not easy to provide a cured product with excellent transparency while blending titanium oxide particles.

Meanwhile, Patent Literature 4 has described a titanium oxide organosol comprising rutile-type titanium oxide particles which is surface-treated with a hydrous oxide of tin or the like, a silane coupling agent, a basic additive, and a water-insoluble organic solvent. It has also described that a dispersion is prepared by adding a UV-curable resin to the organosol, and the dispersion is applied and the water-insoluble organic solvent is evaporated, followed by irradiation with ultraviolet rays to form a coating film with a high refractive index and high hardness, which is suitable for use in optical elements. However, the dispersion described in Patent Literature 4 contains a large amount of the water-insoluble organic solvent. Furthermore, even when the dispersion is processed into a coating film, a solvent residual ratio is too high for the film to be suitably used as a sealant for electronic devices.

### CITATION LIST

### Patent Literature

Patent Literature 1: WO 2017/170888 A1
Patent Literature 2: WO 2013/005441 A1
Patent Literature 3: JP 2020-26515 A
Patent Literature 4: WO 2021/193262 A1

### SUMMARY OF INVENTION

### Technical Problem

To solve the above problems, an objective of the present invention is to provide a dispersion which contains titanium oxide particles, has a higher refractive index, exhibits excellent transparency, has a low volatile solvent content, exhibits a low viscosity, and exhibits excellent viscosity stability, and a production method therefor. Another objective of the present invention is to provide a sealant made of such a dispersion, and a cured product prepared by curing the dispersion and uses thereof.

### Solution to Problem

The above problems are solved by providing a dispersion comprising titanium oxide particles, a silane coupling agent and a monomer having a polymerizable functional group, wherein
the titanium oxide particles are particles of a rutile-type titanium oxide whose core is surface-treated with a hydrous oxide of tin or zirconium and in which a content of titanium oxide is 70 to 95% by mass in terms of TiO₂, and a content of the hydrous oxide of tin or zirconium is 5 to 30% by mass in terms of SnO₂ or ZrO₂;
a viscosity of the monomer at 25° C. is 100 mPa·s or less;
the amount of an ignited solid when the dispersion is ignited at 925° C. for 2 hours is 15 to 55% by mass;
a content of the silane coupling agent in the dispersion is 2 to 15% by mass; a content of the monomer is 30 to 85% by mass; a content of an organic solvent having no polymerizable functional groups is 10% by mass or less; and
a viscosity of the dispersion at 25° C. is 500 mPa·s or less.

Here, it is preferable that a wet specific surface area of the titanium oxide particles is 20 to 150 m²/g as determined by pulse NMR. It is also preferable that the titanium oxide particles are deflocculated using a basic additive. It is also preferable that for a liquid with the amount of the ignited solid of 5% by mass prepared by diluting the dispersion with the monomer, the titanium oxide particles have an average particle diameter of 20 to 50 nm. It is also preferable that for a liquid with the amount of the ignited solid of 5% by mass prepared by diluting the dispersion with the monomer, a haze at a light path length of 10 mm is 40% or less.

A preferable embodiment is a curable sealant made of the above dispersion. Here, it is more preferable that the sealant is used for sealing an optical element. Another preferable embodiment of the present invention is a cured product prepared by curing the above dispersion. Here, it is preferable that the cured product has a refractive index of 1.6 or more at 20° C. and 633 nm. It is also preferable that a residual ratio of the organic solvent in the cured product is 0.1 to 10% by mass. A further preferable embodiment is an optical element sealed by the cured product.

The above problems can be also solved by providing a method for producing the dispersion, comprising removing water from the aqueous dispersion of the titanium oxide particles followed by replacing with the organic solvent; adding the silane coupling agent to the dispersion obtained; and then removing the organic solvent followed by replacing with the monomer. Here, it is preferable that the silane coupling agent and a basic additive are added to the dispersion replaced with the organic solvent to deflocculate the titanium oxide particles and then the organic solvent is removed and replaced with the monomer.

### Advantageous Effects of Invention

A dispersion of the present invention contains titanium oxide particles, has a higher refractive index, exhibits excellent transparency, has a low volatile solvent content, exhibits a low viscosity, and exhibits excellent viscosity stability. This dispersion can be easily cured by UV irradiation or the like, and suitable as a sealant for an electronic device, particularly as a sealant for an optical element. Such a dispersion can be produced by the production method of the present invention.

### DESCRIPTION OF EMBODIMENTS

A dispersion of the present invention is a dispersion containing surface-treated titanium oxide particles, a silane coupling agent and a monomer having a polymerizable functional group. The dispersion will be described below.

The titanium oxide particles contained in the dispersion of the present invention are particles obtained by surface-treating a rutile-type titanium oxide core with a hydrous oxide of tin or zirconium. The titanium oxide contained in the particles has a rutile-type crystal form. This increases a refractive index and reduces a photocatalyst activity, so that when used as a sealant, it is unlikely to adversely affect electronic devices. A hydrous oxide of tin or zirconium present on the surface of the titanium oxide core has a high affinity with a silane coupling agent and a basic additive, and is thus useful for stably dispersing the titanium oxide particles in a dispersion medium. This also makes it possible to suppress viscosity increase of the dispersion over time, and gives a dispersion with high viscosity stability. Moreover, since the hydrous oxide of tin or zirconium has a relatively higher refractive index, decrease of the refractive index caused by surface treatment can be inhibited.

In the particles, a content of titanium oxide is 70 to 95% by mass in terms of TiO₂, and a content of the hydrous oxide of tin or zirconium is 5 to 30% by mass in terms of SnO₂ or ZrO₂. When the content of titanium oxide is 70% by mass or more, a dispersion liquid with a high refractive index can be obtained. The content of titanium oxide is preferably 75% by mass or more, more preferably 80% by mass or more. Meanwhile, the content of the hydrous oxide of tin or zirconium is preferably 25% by mass or less, more preferably 20% by mass or less. Furthermore, when the content of the hydrous oxide of tin or zirconium is 5% by mass or more, viscosity stability of the dispersion of the present invention is improved, and transparency is also improved. The content of the hydrous oxide of tin or zirconium is preferably 7% by mass or more, more preferably 8% by mass or more. Meanwhile, the content of titanium oxide is preferably 93% by mass or less, more preferably 92% by mass or less. The content herein is expressed as a percentage when the total mass of the oxides or hydrous oxides of metals or silicon contained in the particles is converted into oxides and taken as 100.

A wet specific surface area of the titanium oxide particles is preferably 20 to 150 m²/g as determined by pulse NMR. If the wet specific surface area is too large, viscosity stability of the dispersion over time is impaired, and the viscosity may increase during storage. The wet specific surface area is more preferably 120 m²/g or less. If the wet specific surface area is less than 20 m²/g, an average particle diameter becomes large and thus a haze increases, possibly leading to insufficient transparency.

A content of an ignited solid in the dispersion of the present invention when being ignited at 925° C. for 2 hours is preferably 15 to 55% by mass. When the amount of the ignited solid is 15% by mass or more, a refractive index of the dispersion increases. The amount of the ignited solid is more preferably 20% by mass or more, further preferably 25% by mass or more. Meanwhile, when the amount of the ignited solid is 55% by mass or less, viscosity of the dispersion can be reduced. The amount of the ignited solid can be 50% by mass or less, 45% by mass or less, 40% by mass or less, or 35% by mass or less. Here, an ignited solid refers to an ash obtained by completely oxidizing the metal components and silicon components by heating a sample dispersion in the air at 925° C. for 2 hours.

It is preferable that a content of TiO₂ in an ignited solid obtained by igniting the dispersion of the present invention at 925° C. for 2 hours is preferably 70 to 95% by mass. When the content of TiO₂ is 70% by mass or more, a dispersion with a high refractive index can be provided. The content of TiO₂ is more preferably 75% by mass or more, further preferably 80% by mass or more. Meanwhile, the content of TiO₂ is preferably 95% by mass or less in the light of viscosity stability and transparency of the dispersion.

The dispersion of the present invention contains a silane coupling agent. With a silane coupling agent, dispersibility of titanium oxide particles is improved, so that a dispersion exhibiting excellent transparency and viscosity stability can be provided. The silane coupling agent can be selected from those known in the art, including vinyltrimethoxysilane, vinyltriethoxysilane, 2-(3,4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, p-styryltrimethoxysilane, 3-acryloxypropyltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, tris-(trimethoxysilylpropyl) isocyanurate, 3-ureidopropyltrialkoxysilane, 3-mercaptopropylmethyldimethoxysilane, and 3-mercaptopropyltrimethoxysilane. Among these, taking into consideration affinity for and reactivity with the monomer used as a dispersion medium, those having a polymerizable functional group are preferable, and those having a polymerizable double bond such as a (meth)acrylic group or a vinyl group are suitable. Among these, a silane coupling agent containing a (meth)acrylic group with good polymerizability is suitable; examples include 3-acryloxypropyltrimethoxysilane and 3-methacryloxypropyltrimethoxysilane.

A content of a silane coupling agent in a dispersion of the present invention is 2 to 15% by mass. With the content of the silane coupling agent being 2% by mass or more, the above addition effect can be successfully achieved. The content of the silane coupling agent is preferably 4% by mass or more, more preferably 5% by mass or more, further preferably 6% by mass or more. Meanwhile, if the silane coupling agent is excessive, a refractive index decreases. The content of the silane coupling agent is preferably 12% by mass or less, more preferably 10% by mass or less. Here, the silane coupling agent may be bonded to the surface of the titanium oxide particles, or some of the alkoxy groups contained in the silane coupling agent may be hydrolyzed.

A dispersion medium in the dispersion of the present invention is a monomer having a polymerizable functional group. By dispersing titanium oxide particles in such a monomer, the polymerization reaction can be allowed to proceed, and the dispersion can be easily cured. There are no particular restrictions to the type of monomer used here as long as it has a polymerizable functional group. Although a monomer having a polymerizable double bond capable of addition polymerization or a monomer having an epoxy group capable of ring-opening polymerization can be used, a monomer having a polymerizable double bond such as a (meth)acrylic group or a vinyl group is preferable in the light of easily curing by ultraviolet rays or the like. Among them, a monomer containing a (meth)acrylic group with good polymerizability is preferable. If the number of (meth)acrylic groups in one monomer molecule is too large, a viscosity increases, and therefore, the number is preferably 1 to 3, more preferably 1 to 2. Here, when multiple monomers are used, a simple average value of the number of (meth)acrylic groups can be within the above range.

Specific examples of the monomer containing a (meth)acrylic group include benzyl (meth)acrylate, phenoxyethyl (meth)acrylate, n-octyl (meth)acrylate, biphenylmethyl (meth)acrylate, phenoxybenzyl (meth)acrylate, ethoxylated phenyl (meth)acrylate, tripropyleneglycol di(meth)acrylate, trimethylolpropane tri(meth)acrylate, naphthalenemethyl (meth)acrylate, and dimethyl (meth)acrylamide.

A viscosity of the monomer used in the present invention at 25° C. is 100 mPa·s or less. By using such a low-viscosity monomer, a viscosity of the resulting dispersion is also low, and a dispersion with excellent fluidity is provided. A viscosity of the monomer is preferably 50 mPa·s or less, more preferably 30 mPa·s or less. Meanwhile, a viscosity of the monomer is usually 1 mPa·s or more. When multiple types of monomers are used, a viscosity of the mixture of these may be within the above range.

A refractive index of the monomer used in the present invention at 20° C. and 589 nm is preferably 1.45 or more, more preferably 1.5 or more, and even more preferably 1.55 or more. Meanwhile, the refractive index of the monomer is generally 1.7 or less. Here, when multiple types of monomers are used, a refractive index of the mixture of these may be within the above range. To increase a refractive index, it is preferable to use a monomer having an aromatic ring in a molecule.

A content of the monomer in the dispersion of the present invention is 30 to 85% by mass. With a content of the monomer being 30% by mass or more, a low-viscosity dispersion can be provided. A monomer content can be 35% by mass or more, 40% by mass or more, 45% by mass or more, 50% by mass or more, or 55% by mass or more. Meanwhile, with excessive monomers, a refractive index cannot be increased. The content of the monomer is preferably 80% by mass or less, more preferably 75% by mass or less.

A content of the organic solvent having no polymerizable functional groups in the dispersion of the present invention is 10% by mass or less. Therefore, the organic solvent is contained in the dispersion of the present invention as an optional component. The organic solvent is preferably a solvent that is mutually miscible with the monomer and has a lower boiling point than the monomer. Ketones, esters, ethers, alcohols and the like can be used. Specific examples include methyl ethyl ketone, acetone, methyl acetate, ethyl acetate, diethyl ether, tetrahydrofuran, methanol, ethanol, propanol, isopropanol, propyleneglycol monomethyl ether, propyleneglycol monomethyl ether acetate. Considering safety in handling and influence on the working environment, a boiling point of the organic solvent is preferably 40° C. or higher, more preferably 50° C. or higher, and further more preferably 60° C. or higher. Meanwhile, in the light of replacement efficiency of the organic solvent to the monomer, the boiling point of the organic solvent is preferably 150° C. or lower, more preferably 120° C. or lower, further more preferably 100° C. or lower. A boiling point difference between the organic solvent and the monomer is preferably 80° C. or more, but even if there is no difference in boiling point, it is not a problem to replace the organic solvent with the monomer.

With a content of the organic solvent being 10% by mass or less, it is possible to suppress volatilization of the organic solvent into the surrounding environment during coating or filling. Furthermore, even if a small amount of organic solvent is incorporated while curing, there is often no problem as long as the organic solvent does not volatilize. The content of the organic solvent is preferably 8% by mass or less, more preferably 6% by mass or less. Meanwhile, a lower content of the organic solvent is advantageous due to less volatilization of the organic solvent, but it is not economical because too much monomer is used for the replacement, or too much energy is required for the replacement, and the stability of the dispersion over time may be deteriorated. The content of the organic solvent in the dispersion of the present invention can be 0.1% by mass or more, 0.5% by mass or more, or 1% by mass or more.

A method for producing the dispersion of the present invention will be described. A preferable method for producing the dispersion comprises removing water from the aqueous dispersion of titanium oxide particles followed by replacing with the organic solvent; adding a silane coupling agent to the dispersion obtained; and then removing the organic solvent followed by replacing with the monomer.

First, a process for preparing an aqueous dispersion of titanium oxide particles will be described. There are no particular restrictions to a method for preparing the aqueous dispersion, and any known method can be used, including a method wherein a water-soluble tin compound (rutile-forming agent) and a water-soluble titanium compound are dissolved in water for hydrolyzation, salts are removed, and then an acid or alkali is added for deflocculation; or a method wherein a water-soluble tin compound is dissolved in water and hydrolyzed by heating to precipitate a portion of the water-soluble tin compound, a water-soluble titanium compound is added for hydrolyzation, salts are removed, and then an acid or alkali is added for deflocculation.

Examples of a water-soluble titanium compound include titanyl sulfate, titanium tetrachloride, and titanium sulfate, and examples of a water-soluble tin compound (rutile-forming agents) include tin sulfate, tin chloride, and tin nitrate. Examples of the acid include hydrochloric acid, nitric acid, and oxalic acid, and examples of the alkali include sodium hydroxide and amines such as tert-butylamine, isopropylamine, diethylamine and triethanolamine. The amount of the tin compound added is generally 1 to 25 parts by mass, preferably 1 to 10 parts by mass in terms of SnO₂, per 100 parts by mass of titanium oxide (in terms of TiO₂).

A specific example of the method for the above process is as follows. First, titanyl sulfate and a small amount of tin sulfate are dissolved in water. The tin compound added is a rutile-forming agent that changes the crystal form of the resulting titanium oxide particles to a rutile type. The resulting aqueous solution is then neutralized with an alkali to precipitate a mixture of hydrous titanium oxide and hydrous tin oxide. This mixture is then filtered and washed with water to obtain a cake, which is then deflocculated with the addition of hydrochloric acid while stirring to obtain an aqueous dispersion of rutile-type titanium oxide particles.

Next, the obtained titanium oxide particles are surface treated. There are no particular restrictions to a method for the surface treatment, and any known method can be used; for example, a method comprising adding a water-soluble compound of tin or zirconium to the aqueous dispersion of rutile-type titanium oxide particles obtained as described above, and then adjusting pH with an acid or alkali; or a method comprising adding a water-soluble compound of tin or zirconium while adjusting pH of the aqueous dispersion of rutile-type titanium oxide particles with an acid or alkali. As a result, the core of the rutile-type titanium oxide is covered with a hydrous oxide of tin or zirconium and then surface-treated. At this time, a content of the hydrous oxide of tin or zirconium in the titanium oxide particles should be adjusted to 5 to 30% by mass in terms of SnO₂ or ZrO₂. Next, a precipitate is, if necessary, filtered and washed, and water is again added to obtain an aqueous suspension of rutile-type titanium oxide particles surface-treated with a hydrous oxide of tin or zirconium. In the aqueous suspension thus obtained, the surface-treated titanium oxide particles were coagulated, and the suspension was cloudy.

Next, the dispersion medium of the aqueous suspension of the surface-treated rutile titanium oxide particles obtained in the above step is replaced with an organic solvent. After adding a water-soluble organic solvent including an alcohol such as methanol, ethanol, and isopropanol, a ketone such as acetone, and an ether such as tetrahydrofuran to the aqueous suspension of titanium oxide particles, the solvent can be replaced with the water-soluble organic solvent by technique such as ultrafiltration, dialysis, evaporation, or the like. Then, if necessary, the dispersion medium can be further replaced with a water-insoluble organic solvent. Examples of the water-insoluble organic solvent include ketones such as methyl ethyl ketone and methyl isobutyl ketone, esters such as methyl acetate and ethyl acetate, and ethers such as diethyl ether. Since water-insoluble organic solvents have good affinity with the monomer replaced later, the replacement process with the monomer becomes easy. Here, a water-soluble organic solvent is a solvent that can be miscible with water at any ratio, while a water-insoluble organic solvent is an organic solvent other than these.

By adding a silane coupling agent to the suspension thus obtained in which titanium oxide particles are dispersed in an organic solvent and mixing, the titanium oxide particles are deflocculated, so that a dispersion liquid in which the titanium oxide particles are finely dispersed in the organic solvent can be obtained. In this case, by further adding an amine or a dispersant having an amine value as a basic additive, deflocculation can be more effectively achieved. Examples of amines which can be used as a basic additive include alkylamines such as tert-butylamine, isopropylamine, diisopropylamine, diethylamine, propylamine, n-butylamine, and isobutylamine; alkanolamines such as triethanolamine, diethanolamine, N-methylethanolamine, and 2-amino-2-methyl-1-propanol; and heterocyclic amines such as pyridine. Examples of a dispersant having an amine value which can be used as a basic additive include dispersants such as DISPERBYK-108, DISPERBYK-109, and DISPERBYK-180 (manufactured by BYK Japan KK). The amount of the basic additive added is preferably 1 to 20 parts by mass per 100 parts by mass of titanium oxide (in terms of TiO₂), but if a boiling point of the basic additive is low, a large portion thereof will be removed from the dispersion by a subsequent replacement process. When being used as a sealant for an electronic device, it may be better for the basic additive not to remain in the dispersion, and in such cases, it is preferable to use a basic additive with a low boiling point. A preferable boiling point is the same as the boiling point of the organic solvent that does not have a polymerizable functional group. In addition, in order to further improve dispersion stability of titanium oxide particles in the dispersion, a dispersant that does not fall under the category of a basic additive (i.e., a dispersant that does not have an amine value) can be added.

The dispersion medium of the dispersion obtained through the above steps is replaced with a monomer having a polymerizable functional group. A replacement method is not particularly restricted, and can be techniques such as ultrafiltration, dialysis, and evaporation. Among them, evaporation is preferable because it is convenient and low cost. The dispersion of the present invention is obtained by evaporating while adding the monomer as appropriate and then concentrating to an appropriate concentration. Alternatively, the dispersion can be concentrated such that a concentration of the dispersion medium becomes 3 to 10% by mass, thereby the dispersion becomes solid form, and then the monomer can be added for replacement. Here, after replacement, it is preferable that the mixture is pulverized by a bead mill or the like.

The dispersion of the present invention has good transparency. Specifically, for a liquid with the amount of an ignited solid of 5% by mass prepared by diluting the dispersion with the monomer, a haze at a light path length of 10 mm is preferably 40% or less. The haze is more preferably 35% or less, and more preferably 30% or less.

It is preferable that for a liquid with the amount of the ignited solid of 5% by mass prepared by diluting the dispersion of the present invention with the monomer used as a dispersion medium, the titanium oxide particles have an average particle diameter of 20 to 50 nm. With the average particle diameter being 50 nm or less, a dispersion exhibiting excellent transparency can be produced. The average particle diameter is more preferably 45 nm or less.

A viscosity of the dispersion of the present invention at 25° C. is 500 mPa·s or less. With a low viscosity, the dispersion can be easily applied when being used as a sealant. For example, it can be applied to a necessary part using an inkjet printer and can easily follow uneven surfaces. Furthermore, when it fills between an electronic device and a cover member, it can easily fill narrow gaps uniformly. A viscosity of the dispersion is preferably 300 mPa·s or less, more preferably 200 mPa·s or less, further preferably 100 mPa·s or less.

There are no particular restrictions to a method for curing the dispersion of the present invention. It can be cured by heating or irradiating with ultraviolet rays or electron beams. Preferably, a polymerization initiator is added before curing, followed by heating or ultraviolet irradiation. The type of the polymerization initiator can be radical polymerization initiators, ionic polymerization initiators, and photopolymerization initiators. When used as a sealant for electronic devices, it is better to avoid heating, and therefore, it is preferable to use a photopolymerization initiator. Specific examples include 1-hydroxycyclohexyl phenyl ketone, bis(2,4,6-trimethylbenzoyl)-phenylphosphine oxide, 3-hydroxybenzophenone, 2,2-dimethoxy-2-phenylacetophenone, 2-methyl-1-[4-(methylthio)phenyl]-2-morpholinopropan-1-one, monoacylphosphine oxide, 4,4′-bis(dimethylamino)benzophenone, and 2,4-diethylthioxanthone, which can be used alone or in combination of two or more.

When the dispersion of the present invention is filled into a narrow space and cured, a residual ratio of the organic solvent (% by mass) of the cured product is equal to a content of the organic solvent content (% by mass) of the dispersion. Therefore, a preferred range of a residual ratio of the organic solvent for the cured product in such a case is the same as a preferred range of a content of the organic solvent of the dispersion of the present invention.

A refractive index of the dispersion of the present invention at 20° C. and 633 nm is preferably 1.55 or more. This makes it possible to obtain a cured product with a high refractive index. The refractive index of the dispersion is more preferably 1.6 or more, and even more preferably 1.65 or more. It is preferable that a refractive index of the cured product obtained by curing the dispersion of the present invention at 20° C. and 633 nm is preferably 1.6 or more. The refractive index is more preferably 1.65 or more, and even more preferably 1.7 or more. By providing a cured product with a high refractive index, when it is used as a sealant for electronic devices, a difference in refractive index between the sealant and a high refractive index member constituting the device can be reduced, thereby reducing light loss due to reflection and/or refraction.

A suitable application of the dispersion of the present invention is a sealant. In order to protect an electronic device from oxygen and moisture, a sealant of the present invention is applied or filled, and then cured to protect the electronic device. In particular, the dispersion of the present invention, which has a high refractive index and high transparency, is suitably used in applications in which light passes through the sealant, such as organic EL elements, liquid crystal elements, and optical elements such as LED elements.

Among these, a sealant used for sealing an organic EL element is useful. An organic EL element is easily deteriorated by oxygen and moisture, and thus it is important to protect them with the sealant. The sealant of the present invention has a low viscosity, and therefore, when the sealant is applied to an organic EL element, it can be applied only to the necessary areas using an inkjet printer or the like, and it can easily follow uneven surfaces. Furthermore, when a gap between the organic EL element and the cover member is filled with the sealant, the sealant of the present invention can easily be filled evenly into the narrow gap because it has a low viscosity.

### EXAMPLES

The present invention will be further specifically described with reference to Examples.

### Example 1

### (Step A: Preparation of an Aqueous Dispersion of Titanium Oxide Particles)

As titanyl sulfate dihydrate (TiOSO₄·2H₂O), 303 g of TM crystals (100 g as TiO₂) manufactured by Tayca Corporation and 4.3 g of tin sulfate (SnSO₄) (3.0 g as SnO₂: 3 parts by mass per 100 parts by mass of TiO₂) were dissolved in 1692.7 g of water. Subsequently, the resulting aqueous solution was then adjusted to pH 7.0 using a 10% by mass aqueous solution of sodium hydroxide to precipitate a mixture of hydrous titanium oxide and hydrous tin oxide. The mixture was then filtered and washed with water to obtain a cake with a solid content of 11.0% by mass. To 936.4 g of this cake were gradually added 278 g of concentrated hydrochloric acid (100 g as HCl) and 785.6 g of water, and the cake was deflocculated with stirring to obtain 2000 g of an aqueous dispersion of rutile-type titanium oxide particles (TiO₂ concentration: 5% by mass).

### (Step B: Surface Treatment of Titanium Oxide Particles)

To 2000 g of the aqueous dispersion of rutile-type titanium oxide particles obtained in step A was added 14.3 g of tin sulfate (SnSO₄) (10.0 g as SnO₂: 10 parts by mass per 100 parts by mass of TiO₂). Subsequently, the aqueous dispersion was adjusted to pH 6.0 using a 10% by mass aqueous solution of sodium hydroxide, and the surface of the core consisting of titanium oxide particles was treated by precipitating a hydrous oxide of tin. Next, the precipitate was filtered and washed, and water was added to adjust a concentration to obtain 1000 g of an aqueous suspension of rutile-type titanium oxide particles (TiO₂ concentration: 10% by mass) surface-treated with 10 parts by mass (in terms of SnO₂) of hydrous oxide of tin per 100 parts by mass of titanium oxide (in terms of TiO₂).

(Step C: Replacement of Dispersion Medium from Water to Organic Solvent)

To 1000 g of the aqueous suspension of surface-treated titanium oxide particles obtained in Step B were added 1000 g of isopropanol and 1000 g of methyl ethyl ketone. Then, the mixture was ultrafiltered while further adding methyl ethyl ketone, and the dispersion medium was replaced with methyl ethyl ketone, to obtain a total of 1000 g of a suspension in methyl ethyl ketone (TiO₂ concentration: 10% by mass). Next, to the suspension were added 25 g of 3-acryloxypropyltrimethoxysilane (25 parts by mass per 100 parts by mass of TiO₂) as a silane coupling agent and 5 g of tert-butylamine (5 parts by mass per 100 parts by mass of TiO₂) as a basic additive, to obtain 1030 g of a dispersion of surface-treated rutile-type titanium oxide particles in methyl ethyl ketone.

(Step D: Replacement of Dispersion Medium from Organic Solvent to Monomer)

To 1030 g of the dispersion in methyl ethyl ketone obtained in Step C was added 500 g of benzyl acrylate (refractive index at 20° C., 589 nm: 1.52; viscosity at 25° C.: 3 mPa·s) as a monomer having a polymerizable functional group. By concentrating the mixture with an evaporator while further adding benzyl acrylate, methyl ethyl ketone was replaced with benzyl acrylate. After concentrating the mixture to 313 g, a dispersion of surface-treated rutile-type titanium dioxide particles was obtained by dispersing the mixture by a bead mill.

### (Evaluation of Dispersion)

The content of methyl ethyl ketone in the dispersion thus obtained was 4.6% by mass. Here, the content of the solvent (methyl ethyl ketone) in the dispersion was determined by quantitating a content (% by mass) of methyl ethyl ketone in the dispersion after creating a calibration curve for methyl ethyl ketone using a gas chromatograph “GASCHROMATOGRAPH GC-14B” manufactured by Shimadzu Corporation.

When the dispersion was ignited at 925° C., the amount of an ignited solid was 31.4% by mass, and the content of TiO₂ was 26.3% by mass. Here, a certain amount (W) of the dispersion (about 1 g) was put into a crucible and heated at 925° C. for 2 hours, and then a mass (h) of the solid was measured and the amount of the ignited solid was calculated using the following equation:

The amount of the ignited solid (% by mass)=(h/W)×100

The content of TiO₂ was determined by analyzing the solid using an X-ray fluorescence analyzer “SUPER MINI” from Rigaku Corporation to measure a TiO₂ content (% by mass) in the dispersion.

From the above analysis results, 313 g of the dispersion contains 26.3% by mass (82.3 g) of TiO₂, 3.4% by mass (10.7 g) of SnO₂, 8.0% by mass (25 g) of 3-acryloxypropyltrimethoxysilane as a silane coupling agent, and 4.6% by mass (14.4 g) of methyl ethyl ketone as an organic solvent. Therefore, the remaining 58% by mass (181 g) can be estimated as benzyl acrylate monomer. Here, it was estimated that 13 parts by mass of SnO₂ per 100 parts by mass of TiO₂ are contained as per a charge ratio. It was assumed that the silane coupling agent did not volatilize and was not hydrolyzed. It was also estimated that isopropanol was replaced with methyl ethyl ketone and thus did not remain, and tert-butylamine (boiling point: 45.5° C.) was volatilized and did not remain.

The viscosity of the dispersion immediately after production was 12 mPa·s. After aging at 40° C. for two weeks, a viscosity was 14 mPa·s, and 17% increase in viscosity was observed. Here, a viscosity (mPa·s) of the dispersion was measured using an E-type viscometer at 25° C. and a rotation number of 60 rpm. A viscosity of the dispersion after aging was measured as described above, at 25° C. after leaving it in a thermostatic bath at 40° C. for two weeks.

For the liquid obtained by diluting with the monomer such that the amount of the ignited solid was 5% by mass, a haze value at a light path length of 10 mm was 28%. Here, the haze value was measured as follows. With the monomer used in preparing the dispersion, the dispersion was diluted such that the amount of the ignited solid became 5% by mass. This diluted liquid was placed in a quartz cell with a light path length of 10 mm, and the haze value (%) of the dispersion was measured using a haze meter “NDH 4000” manufactured by Nippon Denshoku Industries Co., Ltd.

The average particle diameter of the particles in the liquid obtained by diluting with the monomer such that the amount of the ignited solid was 5% by mass was 36 nm. Here, a method for measuring the average particle diameter was as follows. With the monomer used in preparing the dispersion, the dispersion was diluted such that the amount of the ignited solid became 5% by mass. A particle size distribution in this diluted dispersion was measured using the “Zeta-Potential & Particle size Analyzer ELSZ-1000” manufactured by Otsuka Electronics Co., Ltd., and a D50 (median diameter) was determined as the average particle diameter (nm).

A wet specific surface area of the particles in the monomer dispersion was 45 m²/g. Here, the wet specific surface area (m²/g) of the particles dispersed in the monomer was measured using an NMR wet specific surface area measuring device “Acorn Area” manufactured by Xigo Nanotools, Inc., USA.

### (Formation of Coating Film)

To the dispersion of titanium oxide particles thus obtained were added 0.3 g of 1-hydroxycyclohexyl phenyl ketone and 0.3 g of bis(2,4,6-trimethylbenzoyl)-phenylphosphine oxide as polymerization initiators, and the mixture was stirred for 1 hour. The dispersion thus obtained was spin-coated onto a microslide glass plate (70×55×1.3 mm) from Matsunami Glass Industry Co., Ltd. at a temperature of 25° C. and a humidity of 50%, at 1000 rpm for a rotation time of 3 seconds. The mixture was then left to stand at 25° C. for 30 minutes, and then irradiated with 580 mJ/cm² ultraviolet light for curing to form a coating film with a thickness of 1 μm.

### (Evaluation of Coating Film)

The refractive index of the coating film was 1.69 before curing, and 1.71 after curing. Here, a refractive index of the coating film was determined by measuring a refractive index of the coating film sample formed on a glass plate at 20° C. and 633 nm using an ellipsometer “DVA-FL3G” from Mizojiri Optical Corporation. The haze of the cured coating film was 0.10%. The haze value (%) of these coating films was measured for the coating film with a thickness of about 1 μm on a glass plate using a haze meter “NDH 4000” from Nippon Denshoku Industries Co., Ltd. The solvent residual ratio of the cured coating film was 0.5% by mass. The solvent residual ratio of the cured coating film was determined as follows. The coating film after curing was peeled from the glass plate, it was analyzed by a thermogravimetric and differential thermal analyzer “TG-DTA7300” from Hitachi High-Tech Science Co., Ltd. at a heating rate of 5° C./min, and the solvent residual ratio (% by mass) was determined from a weight loss ratio at 100° C. The above results are summarized in Tables 1 to 3 along with the results of other examples and comparative examples.

### Example 2

A dispersion in which surface-treated rutile-type titanium oxide particles were dispersed in a monomer was prepared as described in Example 1, except that in Step D, phenoxyethyl acrylate was used as the monomer and the mixture was concentrated to 341 g, and then a coating film was formed.

### Example 3

A dispersion in which surface-treated rutile-type titanium oxide particles were dispersed in a monomer was prepared as described in Example 1, except that in Step B, the amount of tin sulfate was 7.1 g (5.0 g as SnO₂: 5 parts by mass per 100 parts by mass of TiO₂), and in Step D, n-octyl acrylate was used as the monomer and the mixture was concentrated to 327 g, and then a coating film was formed.

### Example 4

A dispersion in which surface-treated rutile-type titanium oxide particles were dispersed in a monomer was prepared as described in Example 1, except that in Step C, 3-methacryloxypropylmethoxysilane was used as a silane coupling agent; the amount of the silane coupling agent was 30 parts by mass per 100 parts by mass of TiO₂; and in Step D, biphenylmethyl acrylate was used as the monomer and the mixture was concentrated to 481 g, and then a coating film was formed.

### Example 5

A dispersion in which surface-treated rutile-type titanium oxide particles were dispersed in a monomer was prepared as described in Example 1, except that in Step C, 3-methacryloxypropylmethoxysilane was used as a silane coupling agent, and in Step D, phenoxybenzyl acrylate was used as the monomer and the mixture was concentrated to 397 g, and then a coating film was formed.

### Example 6

A dispersion in which surface-treated rutile-type titanium oxide particles were dispersed in a monomer was prepared as described in Example 1, except that in Step C, 3-methacryloxypropylethoxysilane was used as a silane coupling agent; the amount of the silane coupling agent was 20 parts by mass per 100 parts by mass of TiO₂; and in Step D, ethoxylated phenyl acrylate was used as the monomer and the mixture was concentrated to 390 g, and then a coating film was formed.

### Example 7

A dispersion in which surface-treated rutile-type titanium oxide particles were dispersed in a monomer was prepared as described in Example 1, except that in Step C, 3-methacryloxypropylethoxysilane was used as a silane coupling agent, and in Step D, ethoxylated phenyl acrylate was used as the monomer and the mixture was concentrated to 394 g, and then a coating film was formed.

### Example 8

A dispersion in which surface-treated rutile-type titanium oxide particles were dispersed in a monomer was prepared as described in Example 1, except that in Step B, the amount of tin sulfate was 42.9 g (30 g as SnO₂: 30 parts by mass per 100 parts by mass of TiO₂), and in Step D, tripropyleneglycol diacrylate was used as the monomer and the mixture was concentrated to 465 g, and then a coating film was formed.

### Example 9

A dispersion in which surface-treated rutile-type titanium oxide particles were dispersed in a monomer was prepared as described in Example 1, except that in Step D, trimethylolpropane triacrylate was used as the monomer and the mixture was concentrated to 597 g, and then a coating film was formed.

### Example 10

A dispersion in which surface-treated rutile-type titanium oxide particles were dispersed in a monomer was prepared as described in Example 1, except that in Step C, trifluoropropyltrimethoxysilane was used as a silane coupling agent, and in Step D, naphthalenemethyl acrylate was used as the monomer and the mixture was concentrated to 480 g, and then a coating film was formed.

### Example 11

A dispersion in which surface-treated rutile-type titanium oxide particles were dispersed in a monomer was prepared as described in Example 1, except that in Step C, trifluoropropyltrimethoxysilane was used as a silane coupling agent, and in Step D, the mixture was concentrated to 343 g, and then a coating film was formed.

### Example 12

In Step B, 13.1 g of zirconium oxychloride octahydrate (5 g as ZrO₂: 5 parts by mass per 100 parts by mass of TiO₂) was added to 2000 g of an aqueous dispersion of titanium oxide particles obtained in Step A, and the pH was adjusted to 6.0 using a 10% by mass aqueous solution of sodium hydroxide. Next, 14.3 g of tin sulfate (10.0 g as SnO₂: 10 parts by mass per 100 parts by mass of TiO₂) was added, and the pH was adjusted to 6.0 using a 10% by mass aqueous solution of sodium hydroxide. In this way, hydrous oxides of zirconium and tin were precipitated on the surface of the core consisting of titanium oxide particles, and the surface was treated. Next, the precipitate was filtered and washed, and water was added to adjust a concentration, to obtain 1000 g of an aqueous suspension of titanium oxide particles (TiO₂ concentration: 10% by mass) surface-treated with 5 parts by mass of hydrous oxide of zirconium (in terms of ZrO₂) and 10 parts by mass of hydrous oxide of tin (in terms of SnO₂) per 100 parts by mass (in terms of TiO₂) of titanium oxide. Furthermore, in Step D, naphthalenemethyl acrylate was used as the monomer and the mixture was concentrated to 498 g. A dispersion in which surface-treated rutile-type titanium oxide particles were dispersed in a monomer was prepared as described in Example 1, except for these, and then a coating film was formed.

### Example 13

In Step B, 17.2 g of sodium silicate No. 3 (SiO₂ concentration: 29% by mass) was added to 2000 g of an aqueous dispersion of titanium oxide particles obtained in Step A (5 g as SiO₂: 5 parts by mass per 100 parts by mass of TiO₂), and then, 14.3 g of tin sulfate (10.0 g as SnO₂: 10 parts by mass per 100 parts by mass of TiO₂) was added, and the pH was then adjusted to 6.0 using a 10% by mass aqueous solution of sodium hydroxide. In this way, hydrous oxides of silicon and tin were precipitated on the surface of the core consisting of titanium oxide particles, and the surface was treated. Next, the precipitate was filtered and washed, and water was added to adjust a concentration, to obtain 1000 g of an aqueous suspension of titanium oxide particles (TiO₂ concentration: 10% by mass) surface-treated with 5 parts by mass of hydrous oxide of silicon (in terms of SiO₂) and 10 parts by mass of hydrous oxide of tin (in terms of SnO₂) per 100 parts by mass (in terms of TiO₂) of titanium oxide. Furthermore, in Step D, the mixture was concentrated to 355 g. A dispersion in which surface-treated rutile-type titanium oxide particles were dispersed in a monomer was prepared as described in Example 1, except for these, and then a coating film was formed.

### Example 14

A dispersion in which surface-treated rutile-type titanium oxide particles were dispersed in a monomer was prepared as described in Example 1, except that in Step C, tert-butylamine was added as a basic additive; furthermore, a dispersant (5 g of “DISPERBYK-111” manufactured by BYK Japan KK; 5 parts by mass per 100 parts by mass of TiO₂) was added; and in Step D, trimethylolpropane triacrylate was used as the monomer and the mixture was concentrated to 498 g, and then a coating film was formed. Here, DISPERBYK-111 is a dispersant which does not have an amine value (that is, an amine value is zero).

### Example 15

A dispersion in which surface-treated rutile-type titanium oxide particles were dispersed in a monomer was prepared as described in Example 1, except that in Step D, dimethylacrylamide was used as the monomer and the mixture was concentrated to 313 g, and then a coating film was formed.

### Example 16

A dispersion in which surface-treated rutile-type titanium oxide particles were dispersed in a monomer was prepared as described in Example 1, except that in Step C, 3-methacryloxypropyltrimethoxysilane was used as a silane coupling agent; after addition of the silane coupling agent and a basic additive, a dispersant (5 g of “DISPERBYK-111” from BYK Japan KK, 5 parts by mass per 100 parts by mass of TiO₂) was further added; and in Step D, the mixture was concentrated to 258 g, and then a coating film was formed.

### Example 17

A dispersion in which surface-treated rutile-type titanium oxide particles were dispersed in a monomer was prepared as described in Example 1, except that in Step C, 3-methacryloxypropyltrimethoxysilane was used as a silane coupling agent; after addition of the silane coupling agent and a basic additive, a dispersant (5 g of “DISPERBYK-111” from BYK Japan KK, 5 parts by mass per 100 parts by mass of TiO₂) was further added; and in Step D, the mixture was concentrated to 229 g, and then a coating film was formed.

### Example 18

A dispersion in which surface-treated rutile-type titanium oxide particles were dispersed in a monomer was prepared as described in Example 1, except that in Step C, 3-methacryloxypropyltrimethoxysilane was used as a silane coupling agent, and in Step D, dimethylacrylamide was used as the monomer and the mixture was concentrated to 206 g, and then a coating film was formed.

### Comparative Example 1

A dispersion in which surface-treated rutile-type titanium oxide particles were dispersed in a monomer was prepared as described in Example 1, except that in Step D, dipentaerythritol hexaacrylate was used as the monomer and the mixture was concentrated to 597 g, and evaluated. A viscosity of the resulting dispersion immediately after production was 9,500 mPa·s, and a viscosity after the aging test was more than 10,000 mPa·s. As a result, it was not possible to measure a wet specific surface area or form a coating film.

### Comparative Example 2

A dispersion in which surface-treated rutile-type titanium oxide particles were dispersed in a monomer was prepared as described in Example 1, except that in Step B, tin sulfate was not added, and in Step D, trimethylolpropane triacrylate was used as the monomer and the mixture was concentrated to 547 g, and then a coating film was formed. The dispersion obtained had a high wet specific surface area, and a high viscosity increase ratio after an aging test.

### Comparative Example 3

A dispersion in which surface-treated rutile-type titanium oxide particles were dispersed in a monomer was prepared as described in Example 1, except that in Step D, trimethylolpropane triacrylate was used as the monomer and the mixture was concentrated to 1194 g, and then a coating film was formed. The dispersion obtained had a low amount of an ignited solid, and thus a low refractive index.

### Comparative Example 4

A dispersion in which surface-treated rutile-type titanium oxide particles were dispersed in a monomer was prepared as described in Example 1, except that in Step B, the amount of tin sulfate was 185.3 g (130 g as SnO₂: 130 parts by mass per 100 parts by mass of TiO₂), and n-octyl acrylate was used as the monomer and the mixture was concentrated to 958 g, and then a coating film was formed. The dispersion obtained had a high wet specific surface area, and a high viscosity increase ratio after an aging test. Furthermore, it has a low refractive index due to the large amount of surface treatment.

### Comparative Example 5

In Step B, 413.8 g of sodium silicate No. 3 (SiO₂ concentration: 29% by mass) was added to 2000 g of an aqueous dispersion of titanium oxide particles obtained in Step A (120 g as SiO₂: 120 parts by mass per 100 parts by mass of TiO₂), and then, 14.3 g of tin sulfate (10.0 g as SnO₂: 10 parts by mass per 100 parts by mass of TiO₂) was added, and the pH was then adjusted to 6.0 using a 10% by mass aqueous solution of sodium hydroxide. In this way, hydrous oxides of silicon and tin were precipitated on the surface of the core consisting of titanium oxide particles, and the surface was treated. Next, the precipitate was filtered and washed, and water was added to adjust a concentration, to obtain 1000 g of an aqueous suspension of titanium oxide particles (TiO₂ concentration: 10% by mass) surface-treated with 120 parts by mass of hydrous oxide of silicon (in terms of SiO₂) and 10 parts by mass of hydrous oxide of tin (in terms of SnO₂) per 100 parts by mass (in terms of TiO₂) of titanium oxide. Furthermore, in Step D, tripropyleneglycol diacrylate was used as the monomer and the mixture was concentrated to 958 g. A dispersion in which surface-treated rutile-type titanium oxide particles were dispersed in a monomer was prepared as described in Example 1, except for these, and then a coating film was formed. The dispersion obtained had a high wet specific surface area, and a high viscosity increase ratio after an aging test. Furthermore, it has a low refractive index due to the large amount of surface treatment.

### Comparative Example 6

In Step C, to 1000 g of an aqueous suspension of surface-treated titanium oxide particles obtained in Step B were added 1000 g of isopropanol and 1000 g of methyl ethyl ketone. Then, the mixture was ultrafiltered while further adding methyl ethyl ketone, and the dispersion medium was replaced with methyl ethyl ketone, to obtain a total amount of 1000 g of a suspension in methyl ethyl ketone (TiO₂ concentration: 10% by mass). In Step C, neither a silane coupling agent nor a basic additive was added. In Step D, 500 g of n-octyl acrylate was added as the monomer, and 70 g of “DISPERBYK-111” manufactured by BYK Japan KK (70 parts by mass per 100 parts by mass of TiO₂) was added as a dispersant. Furthermore, the mixture was concentrated by an evaporator while adding n-octyl acrylate, to replace with n-octyl acrylate. The slurry was dispersed by a bead mill, to obtain 915 g of a dispersion in which surface-treated rutile-type titanium oxide particles were dispersed in a monomer. A dispersion was prepared as described in Example 1, except for these, and a coating film was formed. The dispersion obtained had a high wet specific surface area, and a high viscosity increase ratio after an aging test. Furthermore, the haze of the dispersion and the coating film was large.

### Comparative Example 7

To 610 g of biphenylmethyl acrylate were added 300 g of titanium oxide powder manufactured by Tayca Corporation “MICRO TITANIUM DIOXIDE MT-05” and 90 g of a dispersant “DISPERBYK-111” manufactured by BYK Japan KK (30 parts by mass per 100 parts by mass of “MT-05”), to form a slurry. Here, titanium oxide powder “MT-05” was titanium oxide particles surface-treated with hydrous oxides of silicon and aluminum. The slurry was dispersed by a bead mill, to obtain 1000 g of a dispersion in which rutile-type titanium oxide particles were dispersed in a monomer, and then a coating film was formed. The average particle diameter of titanium oxide in the dispersion obtained was large and a haze of the coating film was very large.

### Comparative Example 8

In step C, 1000 g of isopropanol and 1000 g of methyl ethyl ketone were added to 1000 g of the aqueous suspension of surface-treated titanium oxide particles obtained in step B. Then, ultrafiltration was performed while further adding methyl ethyl ketone, and the dispersion medium was replaced with methyl ethyl ketone, to obtain a total amount of 200 g of a suspension in methyl ethyl ketone (TiO₂ concentration: 50% by mass). Next, 25 g of 3-acryloxypropyltrimethoxysilane (25 parts by mass per 100 parts by mass of TiO₂) as a silane coupling agent and 5 g of tert-butylamine (5 parts by mass per 100 parts by mass of TiO₂) as a basic additive were added to obtain 230 g of a dispersion of surface-treated titanium oxide particles in methyl ethyl ketone. To the dispersion was added 100 g of benzyl acrylate, to give a dispersion in which surface-treated rutile-type titanium oxide particles were dispersed in the monomer. A dispersion was prepared as described in Example 1, except for these, and then a coating film was formed. The solvent content in the dispersion obtained was high, and the solvent residual ratio of the coating film was high.

TABLE 1

| | Particle core | | Particle surface | | Silane coupling agent | | Basic | |
|---|---|---|---|---|---|---|---|---|
| | TiO₂ | SnO₂ | SnO₂ | Others | | Amount | additive | Dispersant |
| | (parts | (parts | (parts | (parts | | (parts | (parts | (parts |
| | by mass) | by mass) | by mass) | by mass) | Type | by mass) | by mass) | by mass) |
| Example 1 | 100 | 3 | 10 | 0 | 3-acryloxypropyltrimethoxysilane | 25 | 5 | 0 |
| Example 2 | 100 | 3 | 10 | 0 | 3-acryloxypropyltrimethoxysilane | 25 | 5 | 0 |
| Example 3 | 100 | 3 | 5 | 0 | 3-acryloxypropyltrimethoxysilane | 25 | 5 | 0 |
| Example 4 | 100 | 3 | 10 | 0 | 3-methacryloxypropyltrimethoxysilane | 30 | 5 | 0 |
| Example 5 | 100 | 3 | 10 | 0 | 3-methacryloxypropyltrimethoxysilane | 25 | 5 | 0 |
| Example 6 | 100 | 3 | 10 | 0 | 3-methacryloxypropyltriethoxysilane | 20 | 5 | 0 |
| Example 7 | 100 | 3 | 10 | 0 | 3-methacryloxypropyltriethoxysilane | 25 | 5 | 0 |
| Example 8 | 100 | 3 | 30 | 0 | 3-acryloxypropyltrimethoxysilane | 25 | 5 | 0 |
| Example 9 | 100 | 3 | 10 | 0 | 3-acryloxypropyltrimethoxysilane | 25 | 5 | 0 |
| Example 10 | 100 | 3 | 10 | 0 | trifluoropropyltrimethoxysilane | 25 | 5 | 0 |
| Example 11 | 100 | 3 | 10 | 0 | trifluoropropyltrimethoxysilane | 25 | 5 | 0 |
| Example 12 | 100 | 3 | 10 | ZrO₂ (5) | 3-acryloxypropyltrimethoxysilane | 25 | 5 | 0 |
| Example 13 | 100 | 3 | 10 | SiO₂ (5) | 3-acryloxypropyltrimethoxysilane | 25 | 5 | 0 |
| Example 14 | 100 | 3 | 10 | 0 | 3-acryloxypropyltrimethoxysilane | 25 | 5 | 5 |
| Example 15 | 100 | 3 | 10 | 0 | 3-acryloxypropyltrimethoxysilane | 25 | 5 | 0 |
| Example 16 | 100 | 3 | 10 | 0 | 3-methacryloxypropyltrimethoxysilane | 25 | 5 | 5 |
| Example 17 | 100 | 3 | 10 | 0 | 3-methacryloxypropyltrimethoxysilane | 25 | 5 | 5 |
| Example 18 | 100 | 3 | 10 | 0 | 3-methacryloxypropyltrimethoxysilane | 25 | 5 | 0 |
| Comparative Example 1 | 100 | 3 | 10 | 0 | 3-acryloxypropyltrimethoxysilane | 25 | 5 | 0 |
| Comparative Example 2 | 100 | 3 | 0 | 0 | 3-acryloxypropyltrimethoxysilane | 25 | 5 | 0 |
| Comparative Example 3 | 100 | 3 | 10 | 0 | 3-acryloxypropyltrimethoxysilane | 25 | 5 | 0 |
| Comparative Example 4 | 100 | 3 | 130 | 0 | 3-acryloxypropyltrimethoxysilane | 25 | 5 | 0 |
| Comparative Example 5 | 100 | 3 | 10 | SiO₂ (120) | 3-acryloxypropyltrimethoxysilane | 25 | 5 | 0 |
| Comparative Example 6 | 100 | 3 | 10 | 0 | — | 0 | 0 | 70 |
| Comparative Example 7 | 100 | 0 | 0 | SiO₂, | — | 0 | 0 | 30 |
| | | | | Al₂O₂ | | | | |
| Comparative Example 8 | 100 | 3 | 10 | 0 | 3-acryloxypropyltrimethoxysilane | 25 | 5 | 0 |

TABLE 2

| | | | | Dispersion composition | | | | |
|---|---|---|---|---|---|---|---|---|
| | | | | | | Silane | | |
| | | | | Content of | | coupling | | |
| | Monomer | | | ignited solid | TiO₂ | agent | Solvent | Monomer |
| | | Refractive | Viscosity | (% by | (% by | (% by | (% by | (% by |
| | Type | Index | (mPa · s) | mass) | mass) | mass) | mass) | mass) |
| Example 1 | Benzyl acrylate | 1.52 | 3 | 31.4 | 26.3 | 8.0 | 4.6 | 58 |
| Example 2 | Phenoxyethyl acrylate | 1.52 | 10 | 27.1 | 22.7 | 7.3 | 3.2 | 64 |
| Example 3 | n-Octyl acrylate | 1.41 | 3 | 30.9 | 27.0 | 7.6 | 4.7 | 58 |
| Example 4 | Biphenylmethyl acrylate | 1.60 | 40 | 21.6 | 18.0 | 5.2 | 3.9 | 71 |
| Example 5 | Phenoxybenzyl acrylate | 1.57 | 25 | 26.8 | 22.5 | 6.3 | 4.2 | 64 |
| Example 6 | Ethoxylated phenyl acrylate | 1.52 | 15 | 26.4 | 22.5 | 6.4 | 4.3 | 64 |
| Example 7 | Ethoxylated phenyl acrylate | 1.52 | 15 | 27.0 | 22.8 | 6.3 | 3.9 | 64 |
| Example 8 | Tripropyleneglycol diacrylate | 1.45 | 15 | 26.0 | 18.6 | 5.4 | 4.5 | 65 |
| Example 9 | Tripmethylolpropane triacrylate | 1.47 | 100 | 17.2 | 14.4 | 4.2 | 4.8 | 75 |
| Example 10 | Naphthalenemethyl acrylate | 1.60 | 45 | 21.6 | 18.0 | 5.2 | 3.8 | 71 |
| Example 11 | Benzyl acrylate | 1.52 | 3 | 31.9 | 26.6 | 7.3 | 4.2 | 58 |
| Example 12 | Naphthalenemethyl acrylate | 1.60 | 30 | 22.1 | 17.8 | 5.0 | 4.5 | 70 |
| Example 13 | Benzyl acrylate | 1.52 | 3 | 31.5 | 25.3 | 7.0 | 4.1 | 59 |
| Example 14 | Tripmethylolpropane triacrylate | 1.47 | 100 | 21.3 | 17.1 | 5.0 | 3.7 | 71 |
| Example 15 | Dimethylacrylamide | 1.47 | 2 | 32.9 | 27.6 | 8.0 | 1.9 | 59 |
| Example 16 | Benzyl acrylate | 1.52 | 3 | 40.2 | 32.5 | 9.7 | 4.1 | 48 |
| Example 17 | Benzyl acrylate | 1.52 | 3 | 44.8 | 35.8 | 10.9 | 4.1 | 42 |
| Example 18 | Dimethylacrylamide | 1.47 | 2 | 50.1 | 40.0 | 12.1 | 1.9 | 41 |
| Comparative Example 1 | Dipentaerythritol hexaacrylate | 1.49 | 3000 | 15.1 | 12.6 | 4.2 | 12.3 | 69 |
| Comparative Example 2 | Tripmethylolpropane triacrylate | 1.47 | 100 | 18.1 | 15.2 | 4.6 | 3.6 | 76 |
| Comparative Example 3 | Tripmethylolpropane triacrylate | 1.47 | 100 | 8.7 | 8.0 | 2.1 | 2.3 | 87 |
| Comparative Example 4 | n-Octyl acrylate | 1.41 | 3 | 21.3 | 8.7 | 2.6 | 11.9 | 65 |
| Comparative Example 5 | Tripropyleneglycol diacrylate | 1.45 | 15 | 22.4 | 9.4 | 2.6 | 12.5 | 63 |
| Comparative Example 6 | n-Octyl acrylate | 1.41 | 3 | 17.3 | 16.1 | 0.0 | 6.9 | 67 |
| Comparative Example 7 | Biphenylmethyl acrylate | 1.60 | 40 | 26.9 | 18.6 | 0.0 | 0.0 | 61 |
| Comparative Example 8 | Benzyl acrylate | 1.52 | 3 | 29.5 | 24.7 | 7.6 | 34.5 | 30 |

TABLE 3

| | Dispersion evaluation | | | | | | | | | |
|---|---|---|---|---|---|---|---|---|---|---|
| | | | | | Average | | | Physical properties of coating film | | |
| | | | | | particle | | Refractive | Refractive | | Solvent |
| | Viscosity | After | Increase | | diameter | Wet specific | index | index | | residual |
| | Initial | aging | ratio | Haze | D50 | surface area | (before | (after | Haze | ratio |
| | (mPa · s) | (mPa · s) | (%) | (%) | (nm) | (m²/g) | curing) | curing) | (%) | (% by mass) |
| Example 1 | 12 | 14 | 17 | 28 | 36 | 45 | 1.69 | 1.71 | 0.10 | 0.5 |
| Example 2 | 48 | 53 | 10 | 26 | 41 | 79 | 1.66 | 1.69 | 0.10 | 0.6 |
| Example 3 | 14 | 18 | 29 | 27 | 38 | 54 | 1.60 | 1.61 | 0.05 | 0.4 |
| Example 4 | 135 | 162 | 20 | 19 | 29 | 42 | 1.67 | 1.72 | 0.02 | 0.6 |
| Example 5 | 110 | 121 | 10 | 24 | 31 | 65 | 1.65 | 1.70 | 0.12 | 0.7 |
| Example 6 | 56 | 62 | 11 | 23 | 39 | 95 | 1.64 | 1.67 | 0.06 | 0.6 |
| Example 7 | 62 | 78 | 26 | 21 | 34 | 95 | 1.68 | 1.70 | 0.11 | 0.8 |
| Example 8 | 58 | 65 | 12 | 28 | 28 | 38 | 1.60 | 1.62 | 0.14 | 0.5 |
| Example 9 | 356 | 450 | 26 | 17 | 32 | 89 | 1.62 | 1.63 | 0.07 | 0.7 |
| Example 10 | 186 | 224 | 20 | 20 | 36 | 92 | 1.70 | 1.74 | 0.06 | 0.6 |
| Example 11 | 11 | 13 | 18 | 29 | 40 | 49 | 1.69 | 1.73 | 0.11 | 0.7 |
| Example 12 | 103 | 125 | 21 | 18 | 35 | 78 | 1.70 | 1.74 | 0.09 | 0.8 |
| Example 13 | 14 | 17 | 21 | 28 | 34 | 85 | 1.63 | 1.68 | 0.13 | 0.6 |
| Example 14 | 350 | 416 | 19 | 15 | 36 | 39 | 1.62 | 1.63 | 0.21 | 0.4 |
| Example 15 | 10 | 11 | 10 | 11 | 26 | 55 | 1.67 | 1.70 | 0.03 | 0.6 |
| Example 16 | 140 | 158 | 13 | 30 | 44 | 65 | 1.72 | 1.75 | 0.13 | 0.6 |
| Example 17 | 250 | 284 | 14 | 36 | 49 | 67 | 1.75 | 1.78 | 0.20 | 0.7 |
| Example 18 | 160 | 174 | 9 | 16 | 28 | 63 | 1.64 | 1.69 | 0.08 | 0.6 |
| Comparative Example 1 | 9500 | >10000 | — | 31 | 71 | unmea- | unmea- | unmea- | unmea- | unmea- |
| | | | | | | surable | surable | surable | surable | surable |
| Comparative Example 2 | 310 | 460 | 48 | 42 | 52 | 193 | 1.64 | 1.65 | 0.21 | 0.8 |
| Comparative Example 3 | 213 | 219 | 3 | 11 | 26 | 23 | 1.48 | 1.50 | 0.01 | 0.4 |
| Comparative Example 4 | 12 | 38 | 217 | 16 | 48 | 162 | 1.43 | 1.49 | 0.05 | 2.3 |
| Comparative Example 5 | 41 | 96 | 134 | 17 | 47 | 194 | 1.48 | 1.51 | 0.07 | 2.1 |
| Comparative Example 6 | 13 | 21 | 62 | 45 | 67 | 177 | 1.60 | 1.49 | 1.09 | 0.9 |
| Comparative Example 7 | 122 | 134 | 10 | 84 | 125 | 85 | 1.65 | 1.74 | 2.30 | 0.0 |
| Comparative Example 8 | 7 | 8 | 14 | 18 | 36 | 40 | 1.60 | 1.65 | 0.03 | 3.5 |

1. A dispersion comprising titanium oxide particles, a silane coupling agent and a monomer having a polymerizable functional group, wherein
the titanium oxide particles are particles of a rutile-type titanium oxide whose core is surface-treated with a hydrous oxide of tin or zirconium and in which a content of titanium oxide is 70 to 95% by mass in terms of TiO₂, and a content of the hydrous oxide of tin or zirconium is 5 to 30% by mass in terms of SnO₂ or ZrO₂;
a viscosity of the monomer at 25° C. is 100 mPa·s or less;
the amount of an ignited solid when the dispersion is ignited at 925° C. for 2 hours is 15 to 55% by mass;
a content of the silane coupling agent in the dispersion is 2 to 15% by mass; a content of the monomer is 30 to 85% by mass; a content of an organic solvent having no polymerizable functional groups is 10% by mass or less; and
a viscosity of the dispersion at 25° C. is 500 mPa·s or less.

2. The dispersion according to claim 1, wherein the amount of the ignited solid is 15 to 45% by mass, and the dispersion has the monomer content of 50 to 85% by mass.

3. The dispersion according to claim 1, wherein a wet specific surface area of the titanium oxide particles is 20 to 150 m²/g as determined by pulse NMR.

4. The dispersion according to claim 1, wherein the titanium oxide particles are deflocculated using a basic additive.

5. The dispersion according to claim 1, wherein for a liquid with the amount of the ignited solid of 5% by mass prepared by diluting the dispersion with the monomer, the titanium oxide particles have an average particle diameter of 20 to 50 nm.

6. The dispersion according to claim 1, wherein for a liquid with the amount of the ignited solid of 5% by mass prepared by diluting the dispersion with the monomer, a haze at a light path length of 10 mm is 40% or less.

7. A curable sealant made of the dispersion according to claim 1.

8. The sealant according to claim 7, which is used for sealing an optical element.

9. A cured product prepared by curing the dispersion according to claim 1.

10. The cured product according to claim 9, having a refractive index of 1.6 or more at 20° C. and 633 nm.

11. The cured product according to claim 9, wherein a residual ratio of the organic solvent is 0.1 to 10% by mass.

12. An optical element sealed by the cured product according to claim 9.

13. A method for producing the dispersion according to claim 1, comprising removing water from the aqueous dispersion followed by replacing with the organic solvent; adding the silane coupling agent to the dispersion obtained; and then removing the organic solvent followed by replacing with the monomer.

14. The method for producing the dispersion according to claim 13, comprising adding the silane coupling agent and a basic additive to the dispersion replaced with the organic solvent to deflocculate the titanium oxide particles and then removing the organic solvent followed by replacing with the monomer.

15. The dispersion according to claim 2, wherein a wet specific surface area of the titanium oxide particles is 20 to 150 m²/g as determined by pulse NMR.

16. The dispersion according to claim 2, wherein the titanium oxide particles are deflocculated using a basic additive.

17. The dispersion according to claim 2, wherein for a liquid with the amount of the ignited solid of 5% by mass prepared by diluting the dispersion with the monomer, the titanium oxide particles have an average particle diameter of 20 to 50 nm.

18. The dispersion according to claim 2, wherein for a liquid with the amount of the ignited solid of 5% by mass prepared by diluting the dispersion with the monomer, a haze at a light path length of 10 mm is 40% or less.

19. A cured product prepared by curing the dispersion according to claim 2, having a refractive index of 1.6 or more at 20° C. and 633 nm.

20. A cured product prepared by curing the dispersion according to claim 2, wherein a residual ratio of the organic solvent is 0.1 to 10% by mass.
